(19) United States
(12) Patent Application Publication
(10) Pub. No.: US 2016/0290641 A1
(43) Pub. Date: Oct. 6, 2016

(54) Lighter Assembly

(71) Applicant: Brady Nix, Fredrick, CO (US)

(72) Inventor: Brady Nix, Fredrick, CO (US)

(21) Appl. No.: 14/676,929

(22) Filed: Apr. 2, 2015

(51) Int. Cl. F23Q 2/34; F21L 4/00; F21V 23/04; F21V 23/02; A24F 9/10; F21V 33/00

(52) U.S. Cl. CPC F23Q 2/34; A24F 9/10; F21V 33/0004; F21V 23/0414; F21V 23/023; F21L 4/00

(57) ABSTRACT

A lighter assembly for includes a lighter. A poking unit is attached to the lighter and the poking unit is selectively extendable from the lighter. Thus, the poking unit may unplug a clogged smoking pipe. An illuminating unit is attached to the lighter. The illuminating unit selectively emits light when the poking unit is extended from the lighter to illuminate the smoking pipe.

### BACKGROUND OF THE DISCLOSURE

### Field of the Disclosure

The disclosure relates to lighter devices and more particularly pertains to a new lighter device for un-plugging a plugged smoking pipe.

### SUMMARY OF THE DISCLOSURE

An embodiment of the disclosure meets the needs presented above by generally comprising a lighter. A poking unit is attached to the lighter and the poking unit is selectively extendable from the lighter. Thus, the poking unit may unplug a clogged smoking pipe. An illuminating unit is attached to the lighter. The illuminating unit selectively emits light when the poking unit is extended from the lighter to illuminate the smoking pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a lighter assembly according to an embodiment of the disclosure.

FIG. 2 is a side perspective view of an embodiment of the disclosure in a deployed position.

FIG. 3 is a left side phantom view of an embodiment of the disclosure.

FIG. 4 is a cross sectional view taken along line 4-4 of FIG. 3 of an embodiment of the disclosure.

FIG. 5 is a bottom view of an embodiment of the disclosure.

FIG. 6 is a perspective in-use view of an embodiment of the disclosure.

### DESCRIPTION OF THE PREFERRED EMBODIMENT

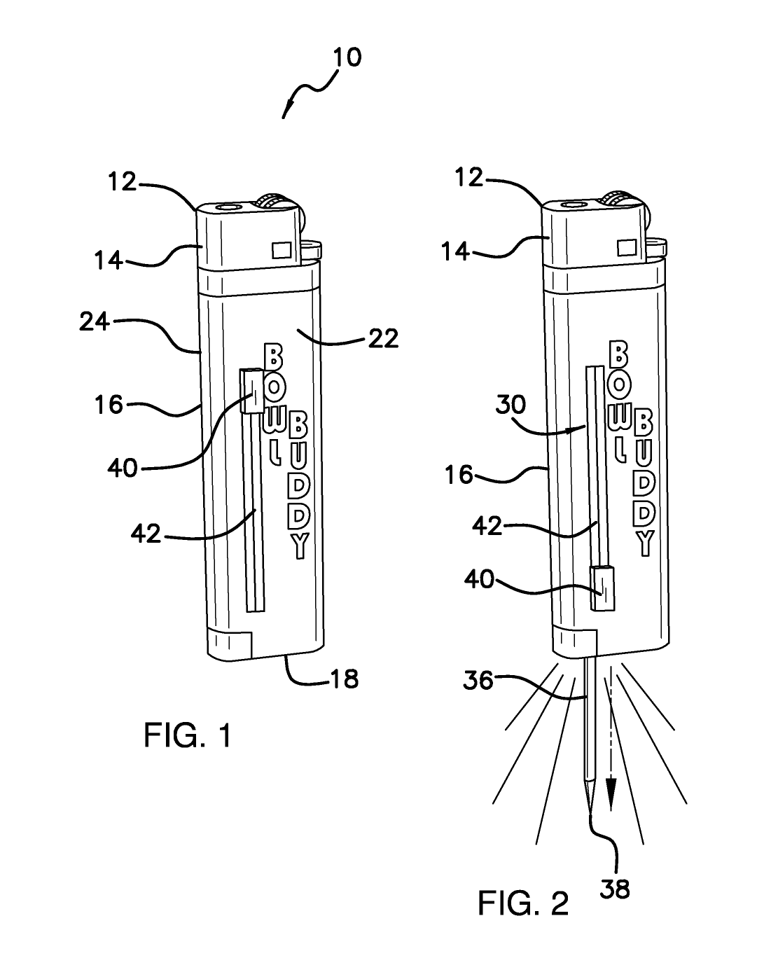

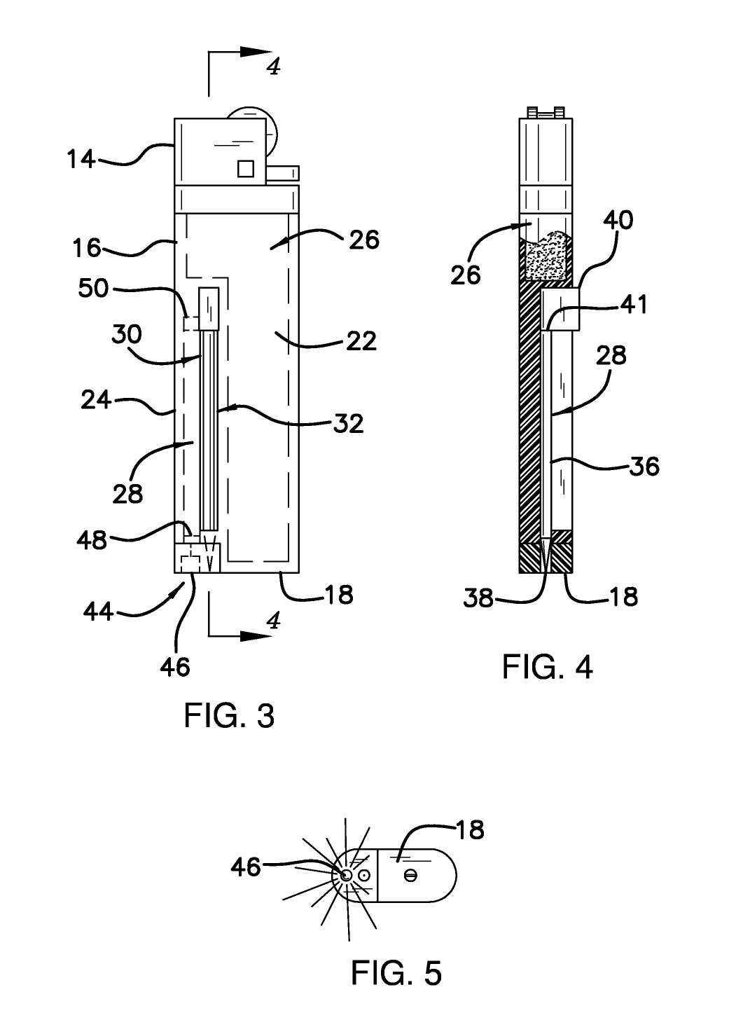

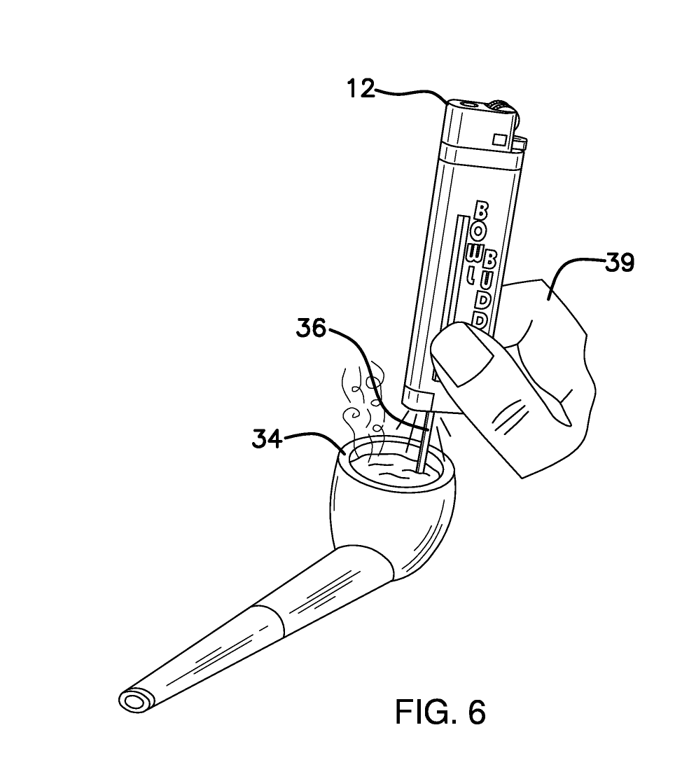

With reference now to the drawings, and in particular to FIGS. 1 through 6 thereof, a new lighter device embodying the principles and concepts of an embodiment of the disclosure and generally designated by the reference numeral 10 will be described.

As best illustrated in FIGS. 1 through 6, the lighter assembly 10 generally comprises a lighter 12 that has a striker portion 14 and a reservoir portion 16. The reservoir portion 16 has a bottom end 18 and a peripheral wall 20 coupled to and extending between the bottom end 18 and the striker portion 14. The peripheral wall 20 has a first lateral side 22 and a front side 24. The reservoir portion 16 has a fluid reservoir 26 therein and a slide space 28 therein. The slide space 28 is positioned between the fluid reservoir 26 and the front side 24 and the slide space 28 is fluidly discrete from the fluid reservoir 26. The first lateral side 22 has a slot 30 extending into the slide space 28 and the slot 30 extends between the bottom end 18 and a point that is closer to the striker portion 14 than the bottom end 18. The lighter 12 may be a disposable cigarette lighter or the like.

A poking unit 32 is attached to the lighter 12 and the poking unit 32 is selectively extendable from the lighter 12. Thus, the poking unit 32 may unplug a clogged smoking pipe 34. The poking unit 32 comprises a rod 36 that has a first end 38 and a second end 41. The rod 36 is slidably positioned within the slide space 28 and the rod 36 is aligned with the slot 30. The rod 36 is positionable in a stored position having the rod 36 being contained within the slide space 28. The rod 36 is positionable in a deployed position having the rod 36 extending outwardly from the bottom end 18 of the reservoir portion 16. The first end 38 tapers to a point and the first end 38 of the rod 36 may be inserted into the smoking pipe 34 when the rod 36 is positioned in the deployed position. Thus, the rod 36 may unplug the smoking pipe 34 when the smoking pipe 34 becomes plugged.

A button 40 is attached to the rod 36 and the button 40 is positioned proximate the second end 41 of the rod 36. The button 40 extends outwardly from the slot 30 in the reservoir portion 16 such that the button 40 may be engaged by a user 39 thereby facilitating the rod 36 to be positioned between the stored position and the deployed position. A gasket 42 is attached to the reservoir portion 16 and the gasket 42 is positioned within the slot 30. The gasket 42 allows the button 40 to slide along the slot 30 and the gasket 42 may prevent material from entering the slide space 28.

An illuminating unit 44 is attached to the lighter 12 and the illuminating unit 44 selectively emitting light when the poking unit 32 is extended from the lighter 12. The illuminating unit 44 comprises a light emitter 46 that is coupled to the bottom end 18 of the reservoir portion 16. The light emitter 46 is positioned adjacent to the front side 24 of the peripheral wall 20 and the light emitter 46 selectively emits light. The light emitter 46 may comprise an LED or the like.

A switch 48 is positioned within the slide space 28 and the switch 48 is positioned proximate the light emitter 46. The switch 48 is electrically coupled to the light emitter 46. A power supply 50 is attached to the rod 36 and the power supply 50 is positioned proximate the second end 41 of the rod 36. The power supply 50 engages the switch 48 when the rod 36 is positioned in the deployed position. Thus, the power supply 50 is placed in electrical communication with the light emitter 46 thereby facilitating the light emitter 46 to be actuated. The light emitter 46 illuminates the smoking pipe 34. The power supply 50 is spaced from the switch 48 when the rod 36 is positioned in the stored position thereby facilitating the light emitter 46 to be de-actuated. The power supply 50 comprises at least one battery 52.

In use, the lighter 12 is utilized in the convention of smoking tobacco or the like. The button 40 is slid downwardly on the lighter 12 to position the rod 36 in the deployed position when the smoking pipe 34 becomes plugged. The light emitter 46 is actuated to illuminate the smoking pipe 34 and the first end 38 of the rod 36 is inserted into the smoking pipe 34 to un-plug the smoking pipe 34. The button 40 is slid upwardly on the lighter 12 to position the rod 36 in the stored position and to de-actuate the light emitter 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lighter assembly having a poker slidably attached thereto wherein said assembly is configured to unplug a clogged smoking pipe, said assembly comprising:
a lighter;
a poking unit being attached to said lighter, said poking unit being selectively extendable from said lighter such that said poking unit is configured to unplug a clogged smoking pipe; and
an illuminating unit being attached to said lighter, said illuminating unit selectively emitting light when said poking unit is extended from said lighter wherein said illuminating unit is configured to illuminate the smoking pipe

2. The assembly according to claim 1, wherein said lighter has a striker portion and a reservoir portion, said reservoir portion having a bottom end and a peripheral wall coupled to and extending between said bottom end and said striker portion, said peripheral wall having a first lateral side and a front side, said reservoir portion having a fluid reservoir therein and a slide space therein, said slide space being positioned between said fluid reservoir and said front side, said slide space being fluidly discrete from said fluid reservoir.

3. The assembly according to claim 2, wherein said first lateral side has a slot extending into said slide space, said slot extending between said bottom end and a point being closer to said striker portion than said bottom end.

4. The assembly according to claim 1, wherein:
said lighter has a slide space and a slot; and
said poking unit comprises a rod having a first end and a second end, said first end tapering to a point, said rod being slidably positioned within said slide space, said rod being aligned with said slot.

5. The assembly according to claim 4, wherein said rod being positionable in a stored position having said rod being contained within said slide space, said rod being positionable in a deployed position having said rod extending outwardly from said bottom end of said reservoir portion.

6. The assembly according to claim 5, wherein said first end of said rod is configured to be inserted into the smoking pipe when said rod is positioned in said deployed position thereby facilitating said rod to unplug the smoking pipe when the smoking pipe becomes plugged.

7. The assembly according to claim 6, further comprising a button being attached to said rod, said button being positioned proximate said second end of said rod, said button extending outwardly from said slot in said reservoir portion wherein said button is configured to be engaged by a user thereby facilitating said rod to be positioned between said stored position and said deployed position.

8. The assembly according to claim 7, further comprising a gasket attached to said reservoir portion, said gasket being positioned within said slot, said gasket allowing said button to slide along said slot, said gasket being configured to prevent material from entering said slide space.

9. The assembly according to claim 1, wherein said illuminating unit comprises a light emitter coupled to said bottom end of said reservoir portion, said light emitter being positioned adjacent to said front side of said peripheral wall, said light emitter selectively emitting light.

10. The assembly according to claim 9, further comprising a switch positioned within said slide space, said switch being positioned proximate said light emitter, said switch being electrically coupled to said light emitter.

11. The assembly according to claim 1, wherein a power supply attached to said rod, said power supply being positioned proximate said second end of said rod.

12. The assembly according to claim 11, wherein:
said illuminating unit includes a switch and a light emitter;
said poking unit includes a rod being positionable in a deployed position; and
said power supply engages said switch when said rod is positioned in said deployed position such that said power supply is placed in electrical communication with said light emitter thereby facilitating said light emitter to be actuated, said light emitter being configured to illuminate the smoking pipe.

13. The assembly according to claim 12, wherein:
said rod is positionable in a stored position;
said power supply is spaced from said switch when said rod is positioned in said stored position thereby facilitating said light emitter to be de-actuated, said power supply comprising at least one battery.

14. A lighter assembly having a poker slidably attached thereto wherein said assembly is configured to unplug a clogged smoking pipe, said assembly comprising:
a lighter having a striker portion and a reservoir portion, said reservoir portion having a bottom end and a peripheral wall coupled to and extending between said bottom end and said striker portion, said peripheral wall having a first lateral side and a front side, said reservoir portion having a fluid reservoir therein and a slide space therein, said slide space being positioned between said fluid reservoir and said front side, said slide space being fluidly discrete from said fluid reservoir, said first lateral side having a slot extending into said slide space, said slot extending between said bottom end and a point being closer to said striker portion than said bottom end;
a poking unit being attached to said lighter, said poking unit being selectively extendable from said lighter such that said poking unit is configured to unplug a clogged smoking pipe, said poking unit comprising
a rod having a first end and a second end, said first end tapering to a point, said rod being slidably positioned within said slide space, said rod being aligned with said slot, said rod being positionable in a stored position having said rod being contained within said slide space, said rod being positionable in a deployed position having said rod extending outwardly from said bottom end of said reservoir portion, said first end of said rod being configured to be inserted into the smoking pipe when said rod is positioned in said deployed position thereby facilitating said rod to unplug the smoking pipe when the smoking pipe becomes plugged,
a button being attached to said rod, said button being positioned proximate said second end of said rod, said button extending outwardly from said slot in said reservoir portion wherein said button is configured to be engaged by a user thereby facilitating said rod to be positioned between said stored position and said deployed position, and
a gasket being attached to said reservoir portion, said gasket being positioned within said slot, said gasket allowing said button to slide along said slot, said gasket being configured to prevent material from entering said slide space;
an illuminating unit being attached to said lighter, said illuminating unit selectively emitting light when said poking unit is extended from said lighter, said illuminating unit comprising
a light emitter coupled to said bottom end of said reservoir portion, said light emitter being positioned adjacent to said front side of said peripheral wall, said light emitter selectively emitting light,
a switch positioned within said slide space, said switch being positioned proximate said light emitter, said switch being electrically coupled to said light emitter, and
a power supply attached to said rod, said power supply being positioned proximate said second end of said rod, said power supply engaging said switch when said rod is positioned in said deployed position such that said power supply is placed in electrical communication with said light emitter thereby facilitating said light emitter to be actuated, said light emitter being configured to illuminate the smoking pipe, said power supply being spaced from said switch when said rod is positioned in said stored position thereby facilitating said light emitter to be de-actuated, said power supply comprising at least one battery.
